(19) United States
(12) Patent Application Publication
(10) Pub. No.: US 2017/0133714 A1
(43) Pub. Date: May 11, 2017

(54) Ionogel Forming a Self-Supporting Film of Solid Electrolyte, Electrochemical Device Incorporating it and Process for Manufacturing the Ionogel

(71) Applicants: Hutchinson, Paris (FR); Centre National de la Recherche Scientifique, Paris (FR); Universite de Nantes, Nantes (FR)

(72) Inventors: David Ayme-Perrot, Huningue (FR); Philippe Sonntag, Avon (FR); Philippe-Franck Girard, Chateufort en Yvelines (FR); Carole Cerclier, Grandchamp des Fontaines (FR); Jean Le Bideau, Nantes (FR); Thierry Brousse, La Chapelle sur Erdre (FR)

(21) Appl. No.: 15/343,526

(22) Filed: Nov. 4, 2016

(30) Foreign Application Priority Data
Nov. 5, 2015 (FR) 1560622

(51) Int. Cl. H01M 10/0565; H01M 10/0525; H01G 11/56; C08J 3/09; C08J 5/18

(52) U.S. Cl. CPC H01M 10/0565; C08J 3/09; C08J 5/18; H01G 11/56; H01M 10/0525; C08J 2367/04; H01M 2300/0085

(57) ABSTRACT

The invention relates to an ionogel that may be used for making a self-supporting film forming a solid electrolyte of an electrochemical device, to such a device incorporating this ionogel and to a process for manufacturing this ionogel. The invention generally applies to all energy storage devices such as supercapacitors or storage batteries (e.g. lithium-ion).

An ionogel according to the invention comprises:
a polymeric confinement matrix which comprises at least one polylactic acid, and
at least one ionic liquid confined in this matrix.

According to the invention, this matrix also comprises a polycondensate of at least one sol-gel molecular precursor bearing hydrolysable group(s).

The present invention relates to an ionogel that may be used for making a self-supporting film forming a solid electrolyte of an electrochemical device, to such a device incorporating this ionogel and to a process for manufacturing this ionogel. The invention generally applies to all energy storage devices such as supercapacitors or storage batteries (e.g. lithium-ion), as exemplary but non-limiting illustrations.

It has been known for a long time to manufacture gels via a hydrolysis and condensation sol-gel process, which, starting with a molecular precursor (known as a “true” solution), leads to the formation of a colloidal solution (known as a “sol”) and then, by connection of the colloidal particles, to the formation of a continuous solid backbone known as a gel.

Moreover, ionic liquids are formed by the association of cations and anions and are in the liquid state at a temperature close to room temperature. They have noteworthy properties, such as zero volatility, high ionic conductivity and also catalytic properties.

It is especially known to confine an ionic liquid in a confinement matrix forming a continuous solid backbone, to obtain an ionogel, i.e. a gel confining an ionic liquid which preserves its ionic conductivity. The ionic liquid thus confined remains by definition contained in the matrix, without flowing or evaporating therefrom.

Such ionogels are especially presented in patent application WO-A1-2005/007746, which teaches the formation of a monolithic ionogel with a rigid confinement matrix of mineral or organomineral type (i.e. essentially inorganic) by polycondensation of a sol-gel molecular precursor bearing hydrolysable group(s), such as an alkoxysilane, which is premixed with the ionic liquid and which forms this confinement matrix after polycondensation.

Patent application WO-A1-2010/092258 teaches the manufacture of a composite electrode for a lithium battery, by pouring an ionogel onto a porous composite electrode, simultaneously forming the composite electrode impregnated with electrolyte and the separating electrolyte having a rigid matrix that is also mineral or organomineral. This ionogel is obtained by mixing an ionic liquid, a lithium salt and this same sol-gel precursor, such as an alkoxysilane.

It has more recently been sought to manufacture ionogels forming solid electrolytes of high ionic conductivity for storage batteries, by confining an ionic liquid in a purely organic confinement matrix, in replacement for the mineral or organomineral matrices of the prior art. CN-B-10 3254461 presents such an ionogel with an organic confinement matrix constituted by a mixture of D and L stereoisomers of a polylactic acid (abbreviated as PLA).

Polylactic acid is a mechanically fragile biobased polymer. Its mechanical strength also decreases above 45° C. On plasticizing it with an ionic liquid, it is known that its mechanical properties and ionic conductivity change.

However, a major drawback of these known ionogels with a confinement matrix constituted by polylactic acid lies in the mechanical strength of the films obtained, which may be insufficient, or even totally unsuitable for their use as self-supporting solid electrolytes, due to the impossibility for the prepared gels of being correctly used in the form of films, or due to the fact that the films that may be obtained cannot be detached from their coating support without deformation or tearing, or alternatively due to the inability of these films to be rolled around a mandrel. In addition, certain ionic liquids that may be used in the latter document, such as those based on imidazolium cations combined with certain anions, may degrade the polylactic acids which confine them.

One aim of the present invention is to propose an ionogel with a confinement matrix of at least one ionic liquid which especially solves these drawbacks, and this aim is achieved in that the Applicant has just discovered, surprisingly, that if a combination of a polylactic acid and of a polycondensate of a sol-gel molecular precursor bearing hydrolysable group(s) is used as confinement matrix for an ionic liquid, then an ionogel may be obtained which has mechanical strength and ionic conductivity that are markedly improved in comparison with those of the two abovementioned ionogels respectively having a matrix resulting solely from the polycondensation of such a precursor and solely formed from polylactic acid, which makes these mixed-matrix ionogels entirely suitable for making, by themselves, a self-supporting film forming a solid electrolyte.

An ionogel according to the invention may thus be used for making a self-supporting film forming a solid electrolyte of an electrochemical device, the ionogel comprising a polymeric confinement matrix which comprises at least one polylactic acid and at least one ionic liquid that is confined in said confinement matrix, and this ionogel is such that said matrix also comprises a polycondensate of at least one sol-gel molecular precursor bearing hydrolysable group(s).

The term “molecular precursor” designates herein the reagent containing one of the base elements of the matrix of the ionogel that are surrounded with ligands, and the term “hydrolysable group” denotes a chemical group bonded to a molecular species and that may be separated therefrom by hydrolysis.

It will be noted that this unprecedented combination, for obtaining said matrix, of two very different macromolecular structures that are, respectively, essentially inorganic and organic, makes it possible to obtain via a synergistic effect self-supporting monolithic films (i.e. which may be detached from their coating support without deformation or tearing, even partial, of the films so as to wind them around a mandrel of small diameter) which have noteworthy mechanical strength allowing them to be readily manipulable and repositionable under good conditions, relative to the mechanical strength of the ionogels of the prior art.

As will be explained hereinbelow, it will also be noted that the presence of a polycondensed three-dimensional network formed from the essentially inorganic structure in the confinement matrix makes it possible to further improve the ionic conductivity of the ionogels of the invention, in comparison with a known ionogel incorporating an identical mass fraction of confined ionic liquid but whose matrix is constituted exclusively by one or more polylactic acids.

According to another characteristic of the invention, said polycondensate forming this essentially inorganic polycondensed network which is preferably of silicic type, may advantageously interpenetrate with the organic structure comprising said at least one polylactic acid, to form said confinement matrix.

Advantageously, an ionogel according to the invention may be characterized by a [(polylactic acid(s))/polycondensate] mass ratio of between 99/1 and 45/55, and even more advantageously between 80/20 and 55/45 (in other words, the mass fraction of said polycondensate in said [(polylactic acid(s))-polycondensate] matrix according to the invention may range from 1% to 55%).

Preferably, an ionogel according to the invention comprises said at least one polylactic acid in a mass fraction that is between 20% and 70%, and said polycondensate in a mass fraction that is between 1% and 30%.

Even more preferentially, an ionogel according to the invention comprises said at least one polylactic acid in a mass fraction that is between 22% and 50%, and said polycondensate in a mass fraction that is between 8% and 25%.

Also preferentially, an ionogel according to the invention comprises said ionic liquid in a mass fraction that is between 35% and 75%, and said polymeric confinement matrix in a complementary mass fraction that is between 65% and 25%.

It will be noted that these ranges of ratios and of mass fractions especially contribute towards giving the ionogels according to the invention satisfactory mechanical strength that is improved relative to the known ionogels.

According to another characteristic of the invention, said at least one sol-gel molecular precursor bearing hydrolysable group(s) may correspond to the general formula R′ₓ(RO)₄₋ₓSi, in which:
x is an integer ranging from 0 to 4,
R is an alkyl group of 1 to 4 carbon atoms, and
R′ is an alkyl group of 1 to 4 carbon atoms, an aryl group of 6 to 30 carbon atoms, or a halogen atom.

Preferably, said precursor is chosen from alkoxysilanes and arylalkoxysilanes, it being pointed out that other silicon-based precursors corresponding to this general formula may be used.

Even more preferentially, the precursor is chosen from:
bifunctional alkoxysilanes, said polycondensate possibly comprising in this case linear chains or rings comprising sequences of formula (R representing an alkyl group):

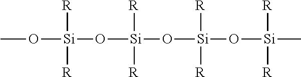

trifunctional alkoxysilanes, said polycondensate then possibly forming a three-dimensional network comprising sequences of formula (R representing an alkyl group):

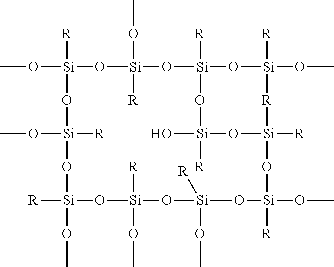

tetrafunctional alkoxysilanes, said polycondensate then possibly forming a three-dimensional network bearing sequences of formula:

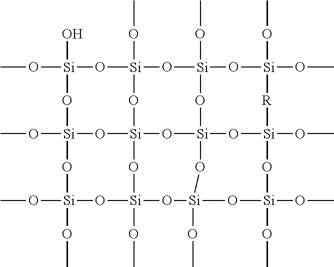

Thus, various types of polycondensed networks may be obtained as a function of the type of precursor used.

According to another characteristic of the invention, said at least one polylactic acid (of formula (C₃H₄O₂)ₙ) may advantageously be amorphous and have a weight-average molecular mass Mw of greater than 100 kDa, preferably greater than or equal to 120 kDa and even more preferentially greater than or equal to 130 kDa.

It will be noted that said at least one lactic acid that may be used in the matrix according to the invention may have a variable content of D and L stereoisomers and that the degree of crystallinity obtained depends on the ratio between the D-polylactic and L-polylactic acids, it being pointed out that a high content of D-polylactic acid is preferred since it promotes the amorphization of the copolymer.

Preferably, said at least one ionic liquid comprises:
a cation with a cyclic nucleus comprising carbon atoms and at least one nitrogen atom, chosen from imidazolium, pyridinium, pyrrolidinium and piperidinium nuclei, the nucleus possibly being substituted on the nitrogen atom with one or two alkyl groups of 1 to 8 carbon atoms and on the carbon atoms with one or more alkyl groups of 1 to 30 carbon atoms, and
an anion chosen from halides, perfluoro derivatives, borates, dicyanamides, phosphonates and bis(trifluoromethanesulfonyl)imides.

It will also be noted that said at least one ionic liquid is preferably of hydrophobic type (the polylactic acid being hydrolyzed in the presence of water), and that a lithium salt may also be added to said at least one ionic liquid so that the ionogel according to the invention can form an electrolyte of a lithium-ion battery.

According to another characteristic of the invention, an ionogel forming said self-supporting film according to the invention advantageously has a mean thickness of greater than or equal to 10 μm and preferably between 30 μm and 70 μm.

Advantageously, the ionogels according to the invention may have an ionic conductivity at 22° C. of greater than 3×10⁻⁶ S·cm⁻¹, preferably greater than 10⁻³ S·cm⁻¹ and, for example, ranging from 3.2×10⁻⁶ S·cm⁻¹ to 1.9×10⁻³ S·cm⁻¹ as a function of the composition of the ionogels obtained.

As indicated above, it will be noted that the ionic conductivity measured for the ionogels of the invention is not only proportionately higher the higher the mass fraction of ionic liquid incorporated into the ionogel, but also that it increases with the presence in the matrix of said polycondensate combined with polylactic acid for the same given mass fraction of ionic liquid.

An electrochemical device according to the invention, such as a supercapacitor or a lithium-ion battery, comprising a solid electrolyte in the form of a self-supporting film (i.e. forming a separating membrane), is characterized in that said solid electrolyte is constituted by an ionogel as defined above in relation with the invention.

A process according to the invention for manufacturing an ionogel as defined above comprises the following steps:

a) preparation of a precursor non-gelled homogeneous solution of the ionogel, via a polycondensation reaction of said at least one sol-gel molecular precursor bearing hydrolysable group(s) in the presence of said at least one polylactic acid and of said at least one ionic liquid; and

b) use in the form of a gelled film of the solution obtained in a) successively by coating the solution on a support, gelling of the coated solution, drying of the gelled solution, and then detachment of the gelled and dried solution to obtain the self-supporting film.

It will be noted that the mass composition of the ionogel finally obtained depends on the amounts of ionic liquid, of polylactic acid and of precursor used in step a).

According to another characteristic of the invention, step a) may be performed via the following successives substeps:

a1) dissolution of said at least one polylactic acid in an organic solvent,

a2) addition of said at least one ionic liquid and of said sol-gel molecular precursor bearing hydrolysable group(s),

a3) homogenization of the reaction medium obtained by stirring, and then

a4) addition of a carboxylic acid (e.g. formic acid of formula HCOOH) in excess, in a [carboxylic acid/molecular precursor] mole ratio preferably greater than or equal to 2, to initiate said polycondensation reaction, after which the solution obtained is stirred for one to two minutes.

As regards the polycondensation reaction of the polycondensed network performed in a4), it may be described via the following reaction mechanism presented as an illustration in the particular case of a tetrafunctional precursor of formula Si—(O—R)₄, in which R is an alkyl group:

Carboxylation:

HCOOH+Si—(O—R)₄ [symbol] (R—O)₃Si—OOCH+R—OH (1)

HCOOH+Si—OH [symbol] Si—OOCH+H₂0 (2)

Esterification:

R—OH+HCOOH [symbol] R—OOCH+H₂0 (3)

Hydrolysis:

Si—O—R+H₂0 [symbol] Si—OH+R—OH (4)

Si—OOCH+H₂0 [symbol] HCOOH+Si—OH (2⁻¹)

Condensation:

2Si—OH→Si—O—Si+H₂0 (5)

Si—OH+Si—O—R→Si—O—Si+R—OH (6)

Si—OH+Si—OOCH→Si—O—Si+HCOOH (7)

Si—OOCH+Si—O—R→Si—O—Si+R—OOCH (8)

Si—O—R+HCOOH→Si—OH+R—OOCH (9)

Advantageously, the abovementioned step b) may be performed directly after homogenization of the solution obtained in a), by coating onto said support which is, for example, based on a polyester such as a polyethylene naphthalate (PEN), using a coating system (e.g. such as a doctor blade or a bar coater). The gelation may take place at room temperature (22-25° C.), and its drying in air and/or in an oven to evaporate off the solvent used in a), it being pointed out that the oven treatment significantly improves the transparency of the film.

It will be noted that the ionogels of the invention are not chemical gels, since there is no covalent three-dimensional structure of the polylactic acid chains and since the network formed by said polycondensate is not always continuous.

Other characteristics, advantages and details of the present invention will emerge on reading the following description of several implementation examples of the invention, which are given as non-limiting illustrations and performed in relation with the attached drawings, among which:

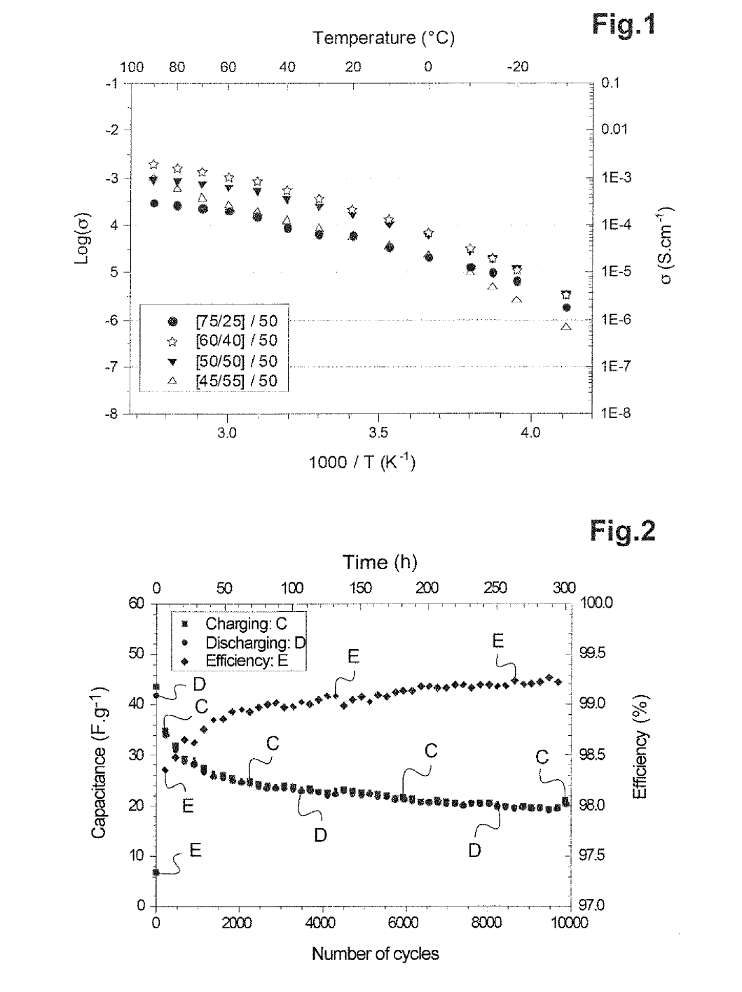

FIG. 1 is a graph showing the change as a function of the temperature of the ionic conductivity of four ionogels according to the invention having different polylactic acid/polycondensate mass ratios, the mass fraction of the ionic liquid being set at 50%,

FIG. 2 is a graph showing the change as a function of the number of cycles of the charge capacity (C), the discharge capacity (D) and the coulombic efficiency (E) of a supercapacitor incorporating an electrolyte according to the invention which has a mass fraction of this ionic liquid of 60%,

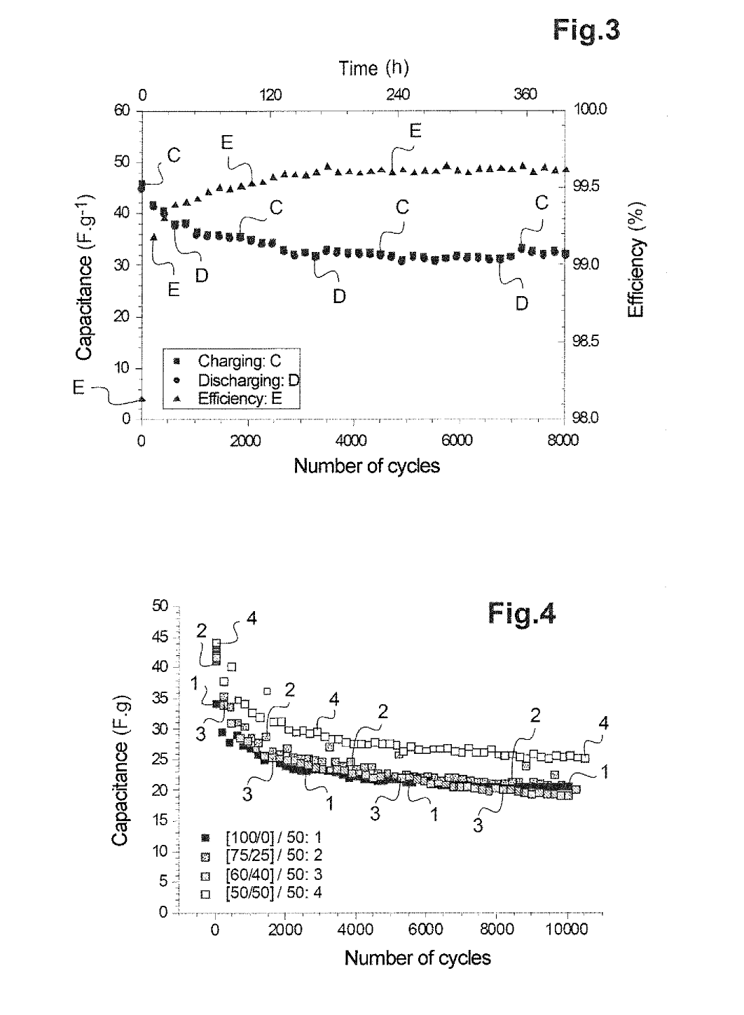

FIG. 3 is a graph showing the change as a function of the number of cycles and of time of the charge capacity (C), the discharge capacity (D) and the coulombic efficiency (E) of a supercapacitor incorporating another electrolyte of the invention with a mass fraction of the ionic liquid of 40%,

FIG. 4 is a graph showing the change as a function of the number of cycles of the capacitance of four supercapacitors incorporating four electrolytes including three according to the invention and one not in accordance with the invention, in galvanostatic cycling between 0 and 2.7 V (0.5 A/g), the mass fraction of ionic liquid being set at 50% for these four electrolytes,

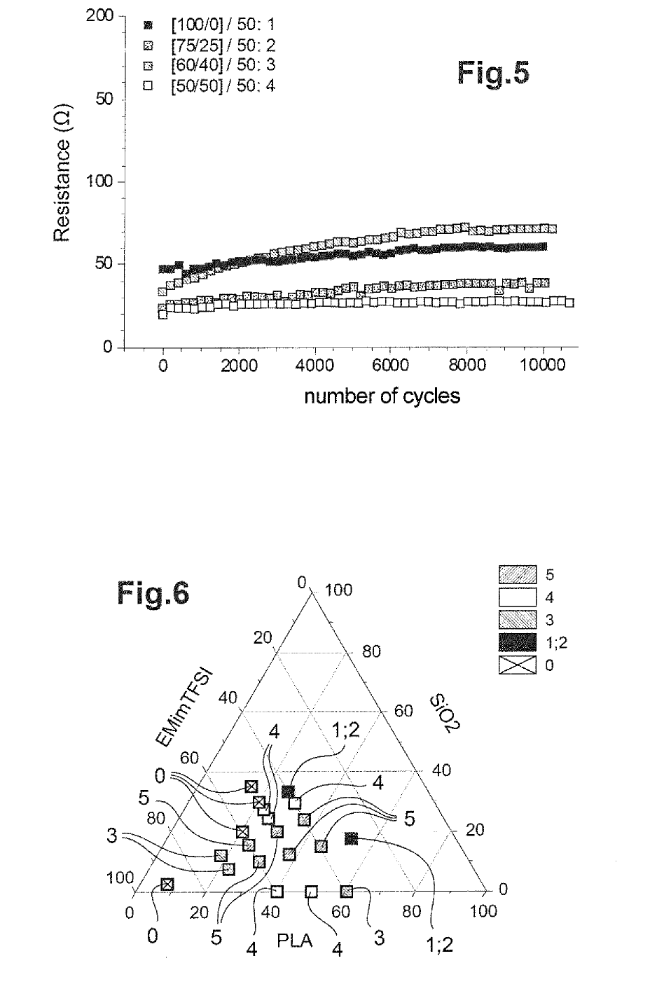

FIG. 5 is a graph showing the change as a function of the number of cycles of the internal resistance of the four supercapacitors of FIG. 4, in galvanostatic cycling between 0 and 2.7 V (0.5 A/g),

FIG. 6 is a ternary diagram illustrating the mechanical strength of films as a function of the respective mass fractions of polylactic acid, of polycondensate and of ionic liquid in the ionogels,

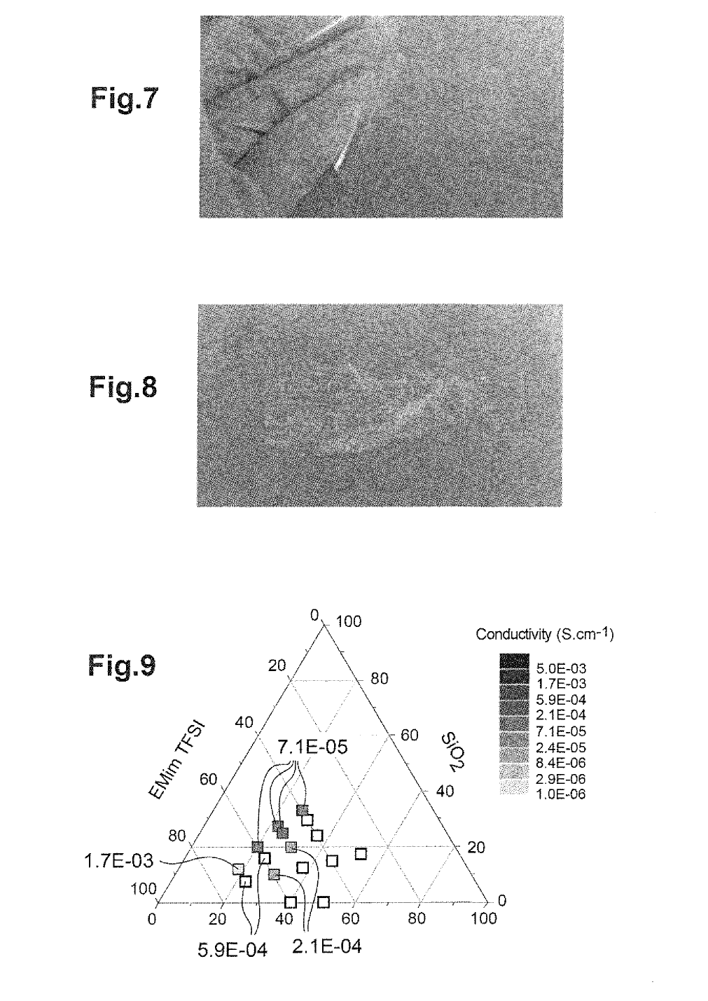

FIG. 7 is a photograph of a film constituted by an ionogel according to the invention, the confinement matrix of which comprises both a polylactic acid and an essentially inorganic polycondensate,

FIG. 8 is a photograph of a “control” film constituted by an ionogel according to the prior art, the confinement matrix of which is constituted exclusively by polylactic acid, and

FIG. 9 is a ternary diagram showing the change in the ionic conductivity at 22° C. of the majority of the films of FIG. 6 showing the influence of the mass fraction of the polycondensate in these ionogels.

The mechanical strength of the films obtained was evaluated qualitatively by mainly analyzing their capacity to be readily detached from their coating support without deformation or tearing, even partial, of the films, and to be wound around a mandrel 5 mm in diameter.

The ionic conductivities of the ionogels tested were determined at 22° C. from measurements taken by complex impedence spectroscopy (using a VMP3 potentiostat from BioLogic Science Instruments).

The following abbreviations were used in the examples:
PLA: polylactic acid; SiO₂: silicic polycondensate.
EMimTFSI: ionic liquid corresponding to the name ethylmethylimidazolium bis(trifluoromethanesulfonyl)imide.
TEOS: silica precursor formed from tetraethoxysilane.
[PLA/SiO₂]/EMimTFSI: [mass ratio between the structure formed by PLA and the SiO₂ network in the confinement matrix] and mass fraction of this ionic liquid in the ionogel.

### EXAMPLE 1 OF MANUFACTURING AN IONOGEL FILM ACCORDING TO THE INVENTION IN COMPARISON WITH TWO “CONTROL” FILMS INCORPORATING PLA NOT IN ACCORDANCE WITH THE INVENTION

380 mg of PLA were mixed with 2.2 mL of solvent so as to obtain a PLA concentration of about 175 g/L. The solution was stirred until the polymer had completely dissolved, i.e. about 2 hours.

340 mg of ionic liquid (EMimTFSI) and 473 μL of silica precursor (TEOS) were then added thereto so as to form an ionogel [PLA/SiO₂]/EMimTFSI with a mass composition of [75/25]/40.

The solution was left to homogenize by magnetic stirring for 10 minutes. An excess of formic acid (643 μL of FA in abbreviated form) was added so as to have a mole ratio r=(number of moles of FA)/(number of moles of TEOS)≧8. The solution was stirred for 1 to 2 minutes.

It was then coated onto a PEN support cleaned beforehand with acetone. A coating speed of 5 cm·s⁻¹ was set, and the height of the deposit was 300 μm. The film was left to gel and to dry in the open air for 24 hours, and was then heated at 110° C. for 1 hour. Finally, this film was left to stand for at least 48 hours before use.

As described in Table 1 below, it was confirmed that the properties of the PLA used greatly influence the final properties of the ionogel film obtained. Specifically, it emerges therefrom that only a PLA of sufficiently high molecular mass (Mw>100 kDa, equal to 130 kDa in the example according to the invention of Case 1 below) made it possible to use the film under good conditions by also giving it satisfactory mechanical strength, measured qualitatively as explained above. It is seen in particular that the PLAs with an Mw of less than or equal to 100 kDa of Cases 2 and 3 did not make it possible to give the ionogel films both good workability and sufficient mechanical strength.

TABLE 1

| | Case 1 | Case 2 | Case 3 |
|---|---|---|---|
| PLA reference | 4060HMw-HD | 6201HMw-LD | 4060LMw-HD |
| Manufacturer | Natureworks | Natureworks | Total Feluy |
| | commercial grade | commercial grade | experimental |
| | | | grade |
| Molecular mass | 130 kDa | 100 kDa | 17 kDa |
| Mw | | | |
| Microstructure | Amorphous | Semicrystalline | Amorphous |
| Solvent used | Acetonitrile | Dichloromethane | Acetonitrile |
| Implementation | Good | Poor | Good |
| of the film | | (solvent too | |
| | | volatile) | |
| Mechanical | Good | Not applicable | Insufficient |
| strength of the | | | (tearing) |
| film | | | |

### “CONTROL” EXAMPLES 2 OF MANUFACTURE OF TWO IONOGEL FILMS RESPECTIVELY HAVING TWO MASS FRACTIONS OF IONIC LIQUID NOT IN ACCORDANCE WITH THE INVENTION

a) First “Control” Example of Manufacture of an Ionogel of Composition [PLA/SiO₂]/EMIMTFSI=[75/25]/90:

92 mg of PLA (PLA4060 HMw-HD from Natureworks of mass Mw=130 kDa) were mixed with 0.5 mL of acetonitrile so as to obtain a PLA concentration of about 180 g/L. The solution was stirred until the polymer had fully dissolved, for about 2 hours. 937 mg of EMimTFSI and 110 μL of TEOS were then added. The solution was left to homogenize by magnetic stirring for 10 minutes, and 150 μL of formic acid were then added so as to have a mole ratio r=(AF)/(TEOS) 8. The solution was stirred for 1 to 2 minutes.

It was then coated onto a PEN support cleaned beforehand with acetone. The coating speed was set at 5 cm·s⁻¹ and the height of the deposit was 300 μm. The film was left to gel and to dry in the open air for 24 hours, and was then heated at 110° C. for 1 hour. Finally, this film was left to stand for at least 48 hours before use. The ionogel obtained not in accordance with the invention had a mass fraction of ionic liquid markedly greater than 75%, which was such that this ionogel had the texture of a paste whose use in film form was not possible.

b) Second “Control” Example of Manufacture of an Ionogel of Composition [PLA/SiO₂]/EMIMTFSI=175/251/30:

387 mg of PLA (same PLA4060 HMw-HD from Natureworks of mass Mw=130 kDa) were mixed with 0.5 mL of acetonitrile so as to obtain a PLA concentration of about 180 g/L. The solution was stirred until the polymer had fully dissolved, for about 2 hours. 227 mg of EMimTFSI and 476 μL of TEOS were then added. The solution was left to homogenize by magnetic stirring for 10 minutes, followed by addition of 648 μL of formic acid so as to have a mole ratio r=(AF)/(TEOS) 8. The solution was stirred for 1 to 2 minutes.

It was then coated onto a PEN support cleaned beforehand with acetone. The coating speed was set at 5 cm·s⁻¹ and the height of the deposit was 300 μm. The film was left to gel and to dry in the open air for 24 hours, and was then heated at 110° C. for 1 hour. Finally, this film was left to stand for at least 48 hours before use. The ionogel obtained had a mass fraction of ionic liquid of only 30%, which was such that this film adhered very strongly to the support: it deformed and/or tore when an attempt was made to remove it from this support.

### EXAMPLE 3 OF MANUFACTURE OF FOUR IONOGEL FILMS ACCORDING TO THE INVENTION HAVING VARIOUS [PLA/SIO₂] MASS RATIOS FOR THE SAME MASS FRACTION OF IONIC LIQUID OF 50%

A comparison was made between four ionogels containing 50% by mass of EMIMTFSI, but with four different [PLA/SiO₂] ratios, in comparison with a “control” ionogel 1 of composition [100/0]/50 characterized by the absence of silicic polycondensate (see FIGS. 4-5). PLA 4060 HMw-HD from Natureworks was used to prepare each ionogel which was characterized by the mass composition [PLA/SiO₂]/EMimTFSI, and prepared according to the following protocol:
Ionogel 2 [75/25]/50: about 380 mg of PLA (Mw=130 kDa) were mixed with 2.2 mL of acetonitrile. The solution was stirred for about 2 hours. 507 mg of EMimTFSI and 462 μL of TEOS were then added thereto. The solution was left to homogenize by magnetic stirring for 10 minutes, followed by addition of 648 μL of formic acid.
Ionogel 3 [60/40]/50: about 215 mg of PLA (Mw=130 kDa) were mixed with 1.2 mL of acetonitrile. The solution was stirred for about 2 hours. 364 mg of EMimTFSI and 530 μL of TEOS were then added thereto. The solution was left to homogenize by magnetic stirring for 10 minutes, followed by addition of 720 μL of formic acid.
Ionogel 4 [50/50]/50: about 217 mg of PLA (Mw=130 kDa) were mixed with 1.2 mL of acetonitrile. The solution was stirred for about 2 hours. 431 mg of EMimTFSI and 800 μL of TEOS were then added thereto. The solution was left to homogenize by magnetic stirring for 10 minutes, followed by addition of 1090 μL of formic acid.
Ionogel 5 [45/55]/50: about 295 mg of PLA (Mw=130 kDa) were mixed with 1.6 mL of acetonitrile. The solution was stirred for about 2 hours. 655 mg of EMimTFSI and 1.33 mL of TEOS were then added thereto. The solution was left to homogenize for 10 minutes, followed by addition of 1.81 mL of formic acid.

Each solution was stirred magnetically for 1 to 2 minutes directly before coating onto a PEN support cleaned beforehand with acetone. The coating speed was set at 5 cm·s⁻¹, and the height of the deposit was 300 μm. Each film was left to gel and to dry in the open air for 24 hours, and was then heated at 110° C. for 1 hour. Finally, each film was left to stand for at least 48 hours before use.

Measurements of the ionic conductivity were taken by varying the temperature for a series of samples whose ionic liquid content was set at 50% by mass. As illustrated in FIG. 1 for all four of the films 2, 3, 4 and 5 according to the invention, the ionic conductivity was about 0.1 mS·cm⁻¹ at a temperature of about 20 to 22° C. and reached 1 mS·cm⁻¹ at higher temperature.

### EXAMPLE 4 OF TESTS IN SUPERCAPACITORS OF TWO ELECTROLYTES OF THE INVENTION WITH THE SAME [PLA/SIO2] MASS RATIO AND TWO DIFFERENT MASS FRACTIONS OF IONIC LIQUID (FIGS. 2-3), AND TESTS OF THE THREE FILMS 2, 3, 4 FORMING ELECTROLYTES OF THE INVENTION COMPARED WITH THE “CONTROL” ELECTROLYTE FILM 1 WITH THE SAME MASS FRACTION OF IONIC LIQUID OF 50% FOR THESE ELECTROLYTES (FIGS. 4-5)

Supercapacitor devices were prepared from assemblies of “Swagelok” type. A first electrode, which was based on porous carbon and deposited beforehand on an aluminium collector, was soaked with ionic liquid EMimTFSI.

Two ionogels according to the invention prepared according to protocol of Case 1 of Example 1 and whose respective mass compositions [PLA/SiO₂]/EMimTFSI were [75/25]/60 (see FIG. 2) and [75/25]/40 (see FIG. 3) were deposited on the first electrode, during two separate first tests. A second electrode was soaked with the same ionic liquid and the whole was placed in contact, so that each of the two ionogels obtained in thin film form formed a self-supporting solid electrolyte between the two electrodes.

The electrochemical characterizations were performed at room temperature using a potentiostat (VMP3, BioLogic Science Instruments). The capacitances were especially determined by galvanostatic cycling. A current I=2 mA was set (i.e. a current density of 0.5 A per gram of carbon of an electrode) for which the potential was varied between 0 and 2.7 V and then between 2.7 V and 0 V, so as to alternate the charging and discharging of the system.

As may be seen in FIGS. 2-3 (which illustrate the charging curve C, discharging curve D and coulombic efficiency curve E obtained) and in FIGS. 4-5 (which illustrate the performance of the electrolyte films 1, 2, 3, 4), the capacitance values obtained for the solid electrolytes 2, 3, 4 according to the invention were of the order of 20 F to 50 F per gram of carbon of an electrode. These devices were capable of functioning in cycling for at least 10 000 cycles. It may be noted that the systems were more stable with 40% by mass of ionic liquid (as illustrated in FIG. 3) and also that the electrochemical performance was improved in the presence of the silicic polycondensate combined with PLA in the confinement matrix.

In conclusion, the results of FIGS. 2-5 demonstrate that these electrochemical devices functioned efficiently, each ionogel film having satisfactorily acted as a separating membrane in the corresponding device.

### EXAMPLE 5 OF MEASURING THE MECHANICAL STRENGTH OF FILMS ACCORDING TO THE INVENTION AND “CONTROL” FILMS (FIG. 6), MANUFACTURED ACCORDING TO THE PROCESS OF EXAMPLE 1 (CASE 1) OR OF EXAMPLE 3 FOR THE FILMS OF THE INVENTION, AND ACCORDING TO THESE PROCESSES BUT WITH [PLA/SIO₂]/EMIMTFSI COMPOSITIONS NOT IN ACCORDANCE WITH THE INVENTION FOR THE “CONTROL” FILMS

The mechanical strength of the ionogel films obtained was evaluated, mainly with regard to their capacity to be easily detached from their PEN coating support and also to be wound around the mandrel 5 mm in diameter, via a qualitative evaluation by means of a note of between 0 and 5.

The note 0 means that a self-supporting film was not obtained by this detachment, and the note 5 means that not only was a self-supporting film obtained, but also that this film was easily wound around said mandrel, having been easy to manipulate by an operator without being impaired in any way. As regards the 1-2 and 3-4 notes, they mean, respectively, that a self-supporting film was not really obtained following the detachment (notes 1-2) and that the self-supporting film obtained was not easily wound around the mandrel and/or was not easy to manipulate without being impaired (notes 3-4).

FIG. 6 shows the performance obtained as a function of the three respective mass fractions of PLA, of SiO₂ and of EMimTFSI of the ionogel films tested according to the invention and the “control” film incorporating the pure ionic liquid EMimTFSI.

Notes 5 and 4 obtained for the films that may be seen in FIG. 6 demonstrate the synergistic effect of the organic structure (PLA) and the essentially inorganic structure (SiO₂), respectively, for obtaining mechanical strength that is very markedly improved for the films of the invention, which contained:
between 35% and 75% by mass of ionic liquid and between 65% and 25% of confinement matrix, which is itself characterized by a [PLA/SiO₂] mass ratio of between [99/1] and [45/55], and
a mass fraction of PLA of between 20% and 70%, preferably of between 30% and 60%, and of silicic polycondensate of between 1% and 30%.

In particular, FIG. 6 shows that, among the films tested according to the invention which had the best mechanical strengths (note 5) were films incorporating the silicic polycondensate in a mass fraction advantageously ranging from 10% to 23%, see the six squares of note 5 characterized by the following three PLA/SiO₂/EMimTFSI mass fractions (fractions expressed as %):

30/10/60, 38/12/50, 45/15/40, 23/17/60, 30/20/50, 37/23/40.

The lower edge of the triangle of FIG. 6 (i.e. with a mass fraction of silicic polycondensate in the ionogels of between 0 and 1%) shows that without the silicic network, the mechanical strengths obtained for the films are less good.

FIG. 7 shows the satisfactory appearance of a self-supporting film according to the invention as tested in FIG. 6, which was characterized by the three PLA/SiO₂/EMimTFSI mass fractions (in %) of 38/12/50, the presence of the silicic polycondensate making this self-supporting film readily manipulable and repositionable for the purpose of using it as a solid electrolyte of a supercapacitor or of a lithium-ion battery, in particular.

It is seen in contrast that the “control” film of FIG. 8 whose confinement matrix is exclusively constituted by polylactic acid, i.e. with the PLA/SiO₂/EMimTFSI mass fractions (in %) of 60/0/40 has a texture that does not make it both self-supporting and capable of being rolled up and of being manipulated and repositioned satisfactorily.

FIG. 9 shows that the ionic conductivity of the ionogel films according to the invention is proportionately higher the higher the mass fraction of ionic liquid in these films. However, and independently of this mass fraction, the diagram of FIG. 9 also demonstrates that the presence of a polycondensate according to the invention, of silicic type in this example of the invention, makes it possible to obtain higher ionic conductivities for a given mass fraction of confined ionic liquid. In particular, this FIG. 9 shows that for a fraction of ionic liquid in an ionogel according to the invention equal to 60% or to 70%, it is the range of mass fractions of said polycondensate ranging from 8% to 18% (including the three films with PLA/SiO₂/EMimTFSI mass fractions of 22/8/70, 18/12/70 and 22/18/60) which affords the highest ionic conductivities, which were greater than 5×10⁻³ S·cm⁻¹ (i.e. 5.0E-03 in abbreviated form in FIG. 9) for this 8-18% mass fraction range of polycondensate.

### COMPARATIVE EXAMPLE 1

A ionogel was prepared according to protocol 5 disclosed in French patent application FR 2 857 004 A.

For this aim, 1 mL of EtMelm⁺NTf₂⁻ (ionic liquid 1-ethyl-3-methylimidazolium bis(trifluorosulfonyl)imide) (3.6 mmol), 2 mL of formic acid (53 mmol) and 1 mL of tetramethoxysilane (6.8 mmol) were mixed together.

In this ionogel, the mass fractions PLA/SiO₂/ionic liquid are 0/22.5/77.5.

Then, the homogeneized ionogel solution was magnetically stirred for one to two minutes directly before coating it onto a PEN support cleaned beforehand with acetone. The coating speed was set at 5 cm·s⁻¹, and the height of the deposit was 300 μm.

The film was left to gel and to dry in the open air with the aim to obtain an auto-supported film.

After these 7 days, the obtained film could not be manipulated. The film broke down.

### COMPARATIVE EXAMPLE 2

A ionogel was prepared as in example comparative 1.

However, the film was left to gel and to dry in the open air for 24 hours and then heated at 110° C. for one hour.

Finally, the film was left to stand for at least 48 hours before use.

The obtained film could not be manipulated without breaking.

These comparatives examples demonstrate that adding PLA is necessary for obtaining an auto-supported film having a good mechanical strength.

1. Ionogel that may be used for making a self-supporting film forming a solid electrolyte of an electrochemical device, the ionogel comprising:
a polymeric confinement matrix which comprises at least one polylactic acid, and
at least one ionic liquid confined in said confinement matrix,
characterized in that said confinement matrix also comprises a polycondensate of at least one sol-gel molecular precursor bearing hydrolysable group(s).

2. Ionogel according to claim 1, characterized in that said polycondensate forms an essentially inorganic polycondensed network which optionally interpenetrates with an organic structure comprising said at least one polylactic acid to form said matrix.

3. Ionogel according to claim 2, characterized in that said essentially inorganic polycondensed network is silicic.

4. Ionogel according to anyone of the preceding claims, characterized by a [(said at least one polylactic acid)/said polycondensate] mass ratio of between 99/1 and 45/55.

5. Ionogel according to claim 4, characterized in that said [(said at least one polylactic acid)/said polycondensate] mass ratio is between 80/20 and 55/45.

6. Ionogel according to claim 1, characterized in that the ionogel comprises said at least one polylactic acid in a mass fractions of between 20% and 70%, and said polycondensate in a mass fractions of between 1% and 30%.

7. Ionogel according to claim 6, characterized in that the ionogel comprises said at least one polylactic acid and said polycondensate in mass fractions respectively between 22% and 50% and between 8% and 25%.

8. Ionogel according to claim 1, characterized in that the ionogel comprises said ionic liquid and said polymeric confinement matrix in mass fractions respectively between 35% and 75% and between 65% and 25%.

9. Ionogel according to claim 1, characterized in that said at least one sol-gel molecular precursor bearing hydrolysable group(s) corresponds to the general formula R′ₓ(RO)₄₋ₓSi, in which:
x is an integer ranging from 0 to 4,
R is an alkyl group of 1 to 4 carbon atoms, and
R′ is an alkyl group of 1 to 4 carbon atoms, an aryl group of 6 to 30 carbon atoms, or a halogen atom.

10. Ionogel according to claim 9, characterized in that said precursor is chosen from alkoxysilanes and arylalkoxysilanes.

11. Ionogel according to claim 10, characterized in that said precursor is chosen from:
bifunctional alkoxysilanes, said polycondensate comprising in this case linear chains or rings comprising sequences of formula (R representing an alkyl group): 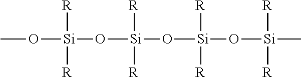
trifunctional alkoxysilanes, said polycondensate forming in this case a three-dimensional network comprising sequences of formula (R representing an alkyl group): 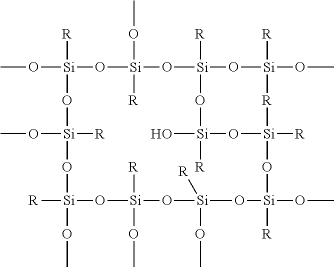
tetrafunctional alkoxysilanes, said polycondensate forming in this case a three-dimensional network comprising sequences of formula:

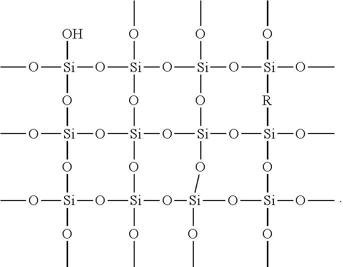

12. Ionogel according to claim 1, characterized in that said at least one polylactic acid is amorphous and has a weight-average molecular mass Mw of greater than 100 kDa.

13. Ionogel according to claim 1, characterized in that said at least one ionic liquid comprises:
a cyclic cation which comprises at least one nitrogen atom and which is chosen from imidazolium, pyridinium, pyrrolidinium and piperidinium cations, and
an anion chosen from halides, perfluoro derivatives, borates, dicyanamides, phosphonates and bis(trifluoromethanesulfonyl)imides.

14. Ionogel according to claim 1, characterized in that the ionogel has a mean thickness of greater than or equal to 10 μm, preferably between 30 μm and 70 μm.

15. Ionogel according to claim 1, characterized in that the ionogel has an ionic conductivity at 22° C. of greater than 3×10⁻⁶S·cm⁻¹, preferably greater than 10⁻³ S·cm⁻¹.

16. Electrochemical device such as a supercapacitor or a lithium-ion battery and comprising a solid electrolyte in the form of a self-supporting separation film, characterized in that said solid electrolyte is constituted by an ionogel according to claim 1.

17. Process for manufacturing an ionogel according to claim 1, characterized in that it comprises the following steps:
a) preparation of a precursor non-gelled homogeneous solution of the ionogel, via a polycondensation reaction of said at least one sol-gel molecular precursor bearing hydrolysable group(s) in the presence of said at least one polylactic acid and of said at least one ionic liquid; and
b) use of the solution obtained in step a) in the form of a gelled film, successively by:
coating the solution onto a support,
gelling the coated solution,
drying the gelled solution, and then
detaching the coated, gelled and dried solution to obtain said self-supporting film.

18. Process for manufacturing an ionogel according to claim 17, characterized in that step a) is performed via the following successive substeps:
a1) dissolution of said at least one polylactic acid in an organic solvent,
a2) addition of said at least one ionic liquid and of said sol-gel molecular precursor bearing hydrolysable group(s),
a3) homogenization of the reaction medium obtained by stirring, and then
a4) addition of a carboxylic acid in excess in a [carboxylic acid/molecular precursor] mole ratio preferably greater than or equal to 2, to initiate said polycondensation reaction.
